(19) United States
(12) Patent Application Publication
(10) Pub. No.: US 2013/0113755 A1
(43) Pub. Date: May 9, 2013

(54) TOUCH SCREEN DISPLAY DEVICE

(71) Applicant: Samsung Electronics Co., Ltd, Gyeonggi-do (KR)

(72) Inventors: Kwang-Lae Kwak, Gyeongsangnam-do (KR); Do-Hun Kim, Seoul (KR); Hyun-Soo Kim, Seoul (KR); Jung-Rin Baek, Gyeonggi-do (KR); Ji-Hyun Oh, Gyeonggi-do (KR); Ki-Wan Lee, Gyeonggi-do (KR)

(73) Assignee: SAMSUNG ELECTRONICS CO., LTD, Gyeonggi-do (KR)

(21) Appl. No.: 13/673,742

(22) Filed: Nov. 9, 2012

(30) Foreign Application Priority Data
Nov. 9, 2011 (KR) 10-2011-0116667

(51) Int. Cl. G06F 3/044

(52) U.S. Cl. CPC G06F 3/044
USPC 345/174

(57) ABSTRACT

A touch screen display device includes a capacitive touch screen display element, a conductive film provided on an outer surface of the display element, and an air layer interposed between the display element and the conductive film. A gap is maintained between the outer surface of the display element and the conductive film by the air layer. Although the screen display device configured as described above has a capacitive touch screen display element, since the capacitive touch screen display element is shielded from being directly exposed to the outside, it is possible for a user to manipulate the capacitive touch screen display element under water or in a highly humid environment, and even in an environment in which the user should wear protective gear.

### CROSS-REFERENCE TO RELATED APPLICATION(S) AND CLAIM OF PRIORITY

The present application is related to and claims priority under 35 U.S.C. §119(a) of an application entitled “Touch Screen Display Device” filed in the Korean Intellectual Property Office on Nov. 9, 2011 and assigned Serial No. 10-2011-0116667, the contents of which are hereby incorporated by reference.

### TECHNICAL FIELD OF THE INVENTION

The present disclosure relates to a display device, and in particular, to a touch screen display device which is adapted to be applicable to a portable terminal or the like.

### BACKGROUND OF THE INVENTION

In general, a display device is employed in ordinary home television sets, various electronic appliances, automobiles, mechanical installments or the like to display images or information for displaying and controlling operating conditions thereof. As mobile communication services have become popularized, display devices for a portable terminal have been rapidly developed. At the initial stage, such display devices were merely capable of providing simple display functions, but recently have been greatly strengthened in terms of performance to such an extent that they can display HD (High Definition) photographs or moving pictures.

Since portable terminals are appliances that are carried by a user, it is important to miniaturize and lighten the terminals. As multimedia services using portable terminals are vitalized, it is a recent trend to increase the size of a display device in such a portable terminal. However, there is a limit in increasing the size of the display device in such a portable terminal while miniaturizing and lightening the terminal. Therefore, efforts to miniaturize and lighten portable terminals are concentrated on reducing the thickness of the portable terminals. In addition, by incorporating a touch screen function into a display device, physical keypads are removed.

Since a touch screen display device is capable of configuring a virtual keypad on a screen, it becomes possible to remove physical keypads from a portable terminal. Accordingly, a portable terminal equipped with a touch screen display device can provide a larger screen as compared to a portable terminal equipped with an ordinary display device. Likewise, a portable terminal equipped with a touch screen display device is rather more suitable for miniaturizing and lightening the terminal as compared to a portable terminal equipped with an ordinary display device. This is because a keypad can be implemented by using such a touch screen display device, which allows a physical keypad to be removed from the portable terminal.

Some groups of users require a waterproofing function for a portable terminal for a professional reason thereof or for the purpose of leisure or the like. However, since such a requirement can be very limiting, the users tend to purchase and use a separate waterproofing pouch. However, although such a waterproofing pouch allows physical keypads to be manipulated without any problem, it causes substantial inconvenience in manipulating a portable terminal equipped with a touch screen display device. For example, such a waterproofing pouch may be possibly destroyed in the process of manipulating the portable terminal received therein. In particular, if the display device is a capacitive touch screen display device, it is very difficult to manipulate the terminal in a state in which the terminal is received in the waterproofing pouch. Such a touch screen display device may be used under water in the exposed state. However, if the touch screen display device is a capacitive touch screen display device, it may not recognize the user's manipulation and may frequently malfunction under water or in a highly humid environment.

If the user wears protective gear, such as gloves in a poor environment, such as a winter leisure sport place or an industrial site, there is an inconvenience in that the user may be required to remove the protective gear in order to manipulate the capacitive touch screen display device.

### SUMMARY OF THE INVENTION

To address the above-discussed deficiencies of the prior art, it is a primary object to provide a touch screen display device that works well even under water or in a highly humid environment.

Also, another aspect of the present disclosure provides a touch screen display device that is configured in a capacitive type but capable of being easily manipulated by a user even if the user wears protective gear, such as gloves, in a poor environment, such as a winter leisure sport place or an industrial site.

In accordance with an aspect of the present disclosure, there is provided a touch screen display device that includes a capacitive touch screen display element, a conductive film provided on an outer surface of the display element, and an air layer interposed between the display element and the conductive film. The air layer maintains a gap between the surface of the display element and the conductive film.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 shows partially in cross-section a touch screen display device in accordance with an embodiment of the present disclosure;

FIG. 2 shows a main part of the touch screen display device shown in FIG. 1 in an enlarged scale;

FIG. 3 is an exploded perspective view of an example in which a part of the touch screen display device shown in FIG. 1 is configured to be removably attached; and

FIG. 4 is a cross-sectional view of a main part in the touch screen display device shown in FIG. 3.

### DETAILED DESCRIPTION OF THE INVENTION

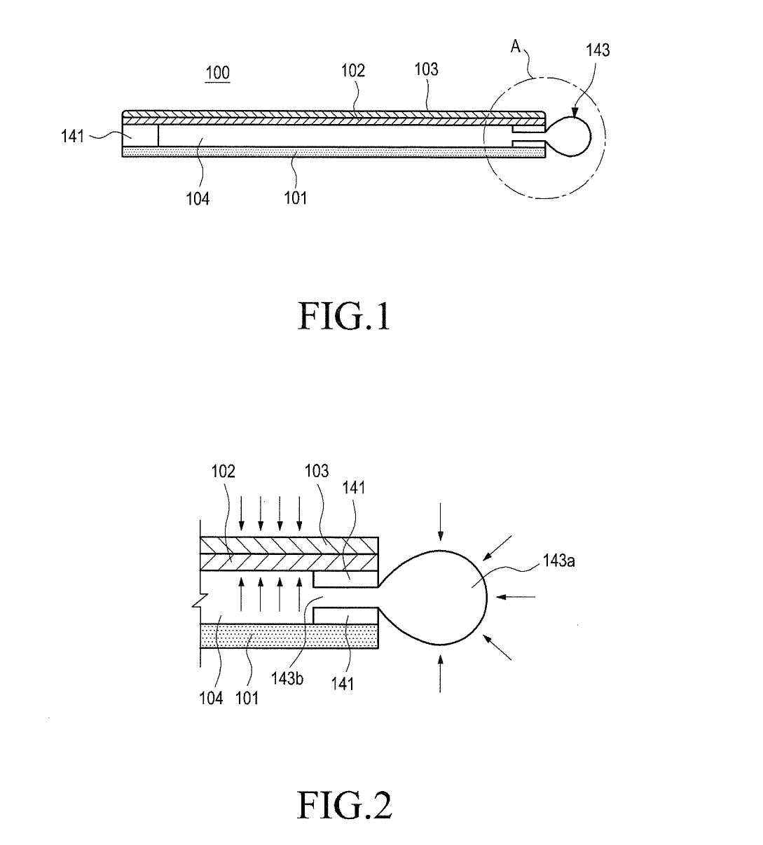

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. Hereinafter, embodiments of the present disclosure will be described with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

As shown in FIGS. 1 and 2, a touch screen display device 100 in accordance with an embodiment of the present disclosure includes a capacitive touch screen display element 101, and a conductive film 102 provided opposite to an outer surface of the display element 101 with an air layer 104 interposed between the display element 101 and the conductive film 102. The air layer 104 maintains the space between the display element 101 and the conductive film 102, and when a user manipulates the touch screen display device, the air layer 104 allows a part of the conductive film 102 (i.e., a part manipulated by the user), to come into contact with the display element 101. The display element 101 recognizes a point touched by the conductive film 102, and produces a signal assigned to the point.

The display element 101 is a capacitive touch screen display element operated by an electric current applied from a human body. Therefore, the display element 101 is operated when a part of the human body touches the display element 101. When the display element 101 is exposed under water or in a highly humid environment, the display element 101 may be operated even if a user's body approaches to the display element 101 rather than touching the display element 101. In addition, when the display element 101 is directly exposed under water or in a highly humid environment, a malfunction may occur in which the display element 101 recognizes a portion untouched by the user's body or an area wider than a portion touched by the user's body as being manipulated by the user. The conductive film 102 and the air layer 104 shield the display element 101 from a highly humid environment or the like to prevent the malfunction of the display element 101.

Although it is desirable that the conductive film 102 has such an elasticity that it can remain in a flat shape or in parallel to the outer surface of the display device 101 with a gap in relation to the outer surface, such a gap can be maintained between the conductive film 102 and the outer surface of the display device 101 with the help of the pressure of the air layer 104. In arranging the conductive film 102 on the outer surface of the display element 101, one or more spacers 141 are preferably arranged around the edges of the conductive film 102. The spacers 141 allow the gap between the display element 101 and the conductive film 102, and hence the thickness of the air layer 104 to be maintained constantly.

A micro-current may be applied to the conductive film 102 due to the user's body current. Accordingly, if the conductive film 102 comes into contact with the display element 101 by being partially deformed due to the user's touch, the display element 101 recognizes it and produces a signal. A protective film 103 may be conformally attached to the outer surface of the conductive film 102. In such a situation, the conductive film 102 may not receive the micro-current produced due to the current induced in the user's body and applied to the conductive film 102. Therefore, when the protective film 103 is conformally attached, it is desirable to make an appliance equipped with the display device 101 apply the micro-current to the conductive film 102. Applying the micro-current to the conductive film 102 may be preferably performed simultaneously when the display element 101 is activated.

When the pressure of the air layer 104 decreases below the external pressure, for example, when the display device 100 is positioned under water, the conductive film 102 is made to come into contact with the display element 101 as the air layer 104 is contracted. This may cause a malfunction of the display device 100 regardless of the user's intention. Therefore, the display device 100 may be provided with a pressure control member 143a so that the pressure of the air layer 104 and the external pressure can be balanced.

The pressure control member 143a can be contracted or expanded in accordance with a difference between its internal and external pressures, in which the internal space of the pressure control member 143a is connected to the air layer 104 through a tube 143b extending through the spacer 141. If the external pressure of the display device 100 is equal to the atmospheric pressure, the pressure control member 143a will be expanded, and if the display device 100 is positioned under water, the pressure control member 143a will be contracted, which causes the pressure of the air layer 104 to be increased. Therefore, the pressure of the air layer 104 is balanced to the external pressure of the display device 100, and if the user does not manipulate this condition, the conductive film 102 remains in a predetermined gap in relation to the display element 101. The spacer 141 functions as a sealing means between the display element 101 and the conductive film 102. That is, the air layer 104 is completely isolated from the external environment by the display element 101, the spacer 141 and the conductive film 102.

Although provided with a capacitive touch screen display element 101, the touch screen display device 100 as described above can exhibit a good operational performance, even if the user's body does not directly touch it. In addition, since the display element 101 is not directly exposed to the external environment, it can accurately recognize a user's manipulation even under water or in a highly humid environment, and can produce a signal. Further, since the user is capable of manipulating the touch screen display device 100 without removing protective gear in an environment where the user wears the protective gear, such as winter leisure sport place or an industrial site, the touch screen display device 100 can be applied to a portable terminal to be usefully utilized.

The display element 101 may be mounted on a portable terminal, and the conductive film 102 may be mounted on a separate bracket. In such a situation, the bracket is configured to be removably attached to the portable terminal. The touch screen display device with this construction allows a user to optionally utilize the bracket.

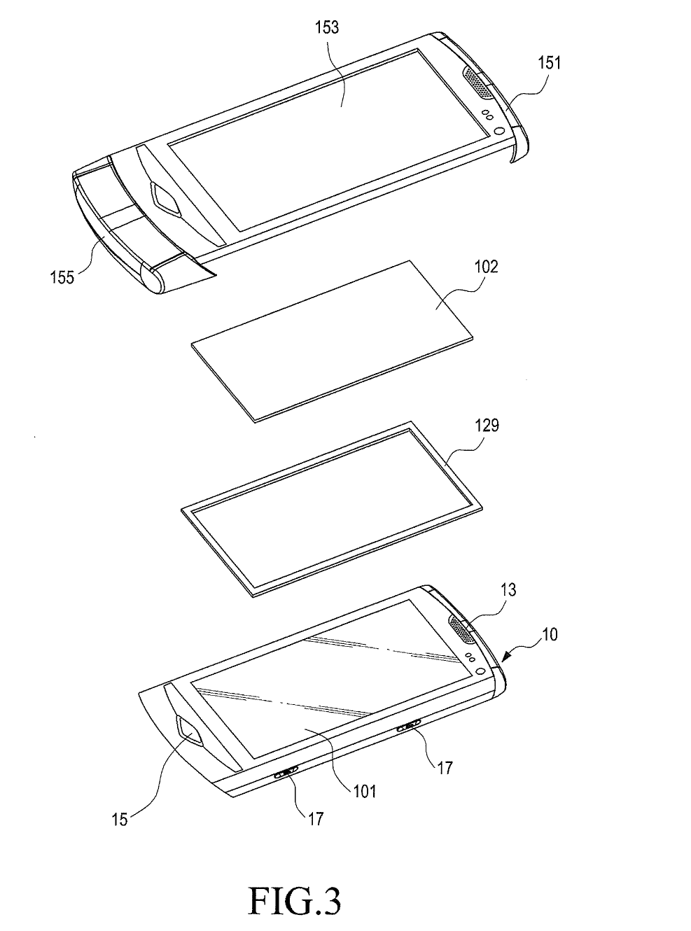

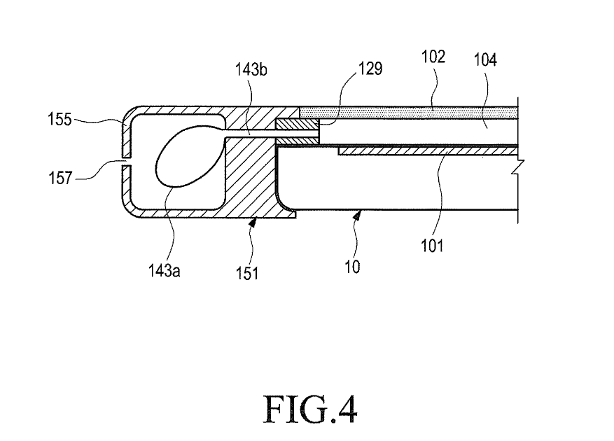

Referring to FIGS. 3 and 4, there is shown an example in which in configuring the touch screen display device 100, the conductive film 102 is mounted on a separate bracket 151, and then the bracket 151 is removably attached to the portable terminal 10 provided with the display element 101.

The display element 101 is provided on the front side of the terminal 10, in which a receiver unit 13 and at least one physical key 15, such as a power button, a menu button or the like, may be provided above and below the display element 101 on the front side of the terminal 10, respectively. In addition, on one or more lateral sides of the terminal 10, there may be provided other physical keys 17 to provide a volume tuning function, a shutter function for photographing, and the like.

The bracket 151 is bound with the terminal 10 to wrap at least one of the lateral sides of the terminal at least partially, and has an opening 153 formed through the front and rear sides thereof to expose the display device 101. In such a situation, the conductive film 102 is arranged on the opening 153 opposite to the outer surface of the display element 101. As described above, a micro-current may be applied to the conductive film 102 from a current induced in a user's body or from a power source housed in the terminal 10 or the bracket 151. When the micro-current is applied from the power source housed in the terminal 10 or the bracket 151, the display device 100 can be manipulated even if the user's body does not directly touch the display device 100. That is, the user can manipulate the display device 100 in a state of wearing protective gear, such as gloves, or by using a separate stylus pen or the like.

If the conductive film 102 is removably provided through the bracket 151, it is desirable that a sealing member 129 is arranged between the inner surface of the bracket 151 and the edges of the inner surface of the conductive film 102. The sealing member 129 allows the conductive film 102 to be anchored to the bracket 151 stably, and allows the air layer 104 to be formed and maintained between the film 102 and the display element 101.

If the conductive film 102 is configured in a modular form with the display device 102, i.e. in the form as shown in FIGS. 1 and 2, the pressure control member 143a will be received within the inside of an appliance, which is provided with the display device 100, for example a portable terminal. Whereas, if the conductive film 102 is configured to be removably attached to the portable terminal as shown in FIGS. 3 and 4, it is desirable that the pressure control member 143a is provided in the bracket 151. The bracket 151 is formed with a pressure control case 155 on a lateral side thereof. The pressure control case 155 provides a space with a predetermined volume in the inside thereof at a side of a space in which the terminal 10 is received, and the pressure control member 143 is received within the pressure control case 155. A through-hole 157 is formed in the pressure control case 155 to connect the internal space of the pressure control case 155 to the outside of the bracket 151. In addition, a tube 143b is provided to extend from the inside of the pressure control case 155 through the sealing member 129, and the pressure control member 143a is connected to the air layer 104 through the tube 143b. As a result, when an external pressure acts on the pressure control member 143a, the pressure control member 143 is expanded or contracted, so that the pressure of the air layer 104 and the external pressure of the display device 100 can be maintained in a balanced state.

Although no description for a protective film is provided in connection with the touch screen display device as shown in FIGS. 3 and 4, it will be understood that the touch screen display device may be also provided with such a protective film conformally attached to the conductive film 102. In addition, if the protective film is conformally attached to the outer surface of the conductive film 102, a micro-current should be applied to the conductive film 102 through a separate power source, or a power source provided from the terminal 10.

Since the touch screen display device configured as described above has a capacitive touch screen display element, and a conductive film positioned opposite to the display element with an air layer interposed between the conductive film and the display element, it is possible to prevent the display element from being directly exposed to the outside. In addition, since a user's manipulation is transmitted to the display element through the conductive film, the user can manipulate well the capacitive touch screen display element even under water or in a highly humid environment. Further, if a micro-current is applied to the conductive film, the capacitive touch screen display element can recognize a point touched by the conductive film without a user removing protective gear, such as gloves, even in an environment in which the user should wear the protective gear. Therefore, if the conductive film is mounted on a separate bracket and the bracket is removably attached to a portable terminal, it is possible to usefully utilize the portable terminal provided with the capacitive touch screen display device even in a condition in which the environment of using the terminal is abruptly changed.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A touch screen display device comprising:
a capacitive touch screen display element;
a conductive film provided on an outer surface of the display element; and
an air layer interposed between the display element and the conductive film,
wherein a gap is maintained between the outer surface of the display element and the conductive film by the air layer.

2. The touch screen display device as claimed in claim 1, further comprising a protective film attached to an outer surface of the conductive film.

3. The touch screen display device as claimed in claim 1, wherein a micro-current is applied to the conductive film simultaneously when the display element is activated.

4. The touch screen display device as claimed in claim 1, wherein an input signal is produced as a result of the conductive film coming into contact with the display element in response to a user's manipulation.

5. The touch screen display device as claimed in claim 1, further comprising a pressure control member connected to the air layer,
wherein the pressure control member is contracted or expanded in accordance with an external pressure to maintain balance between the air layer and the external pressure.

6. The touch screen display device as claimed in claim 5, further comprising a protective film attached to an external surface of the conductive film.

7. The touch screen display device as claimed in claim 5, wherein an input signal is produced as a result of the conductive film coming into contact with the display element in response to a user's manipulation.

8. The touch screen display device as claimed in claim 1, further comprising:
a bracket configured to surround the conductive film; and
a sealing member arranged along the edges of one side of the conductive film,
wherein the display element is provided in a portable terminal, and the bracket is configured to be removably attached to the portable terminal.

9. The touch screen display device as claimed in claim 8, wherein the air layer is formed by being enclosed by the outer surface of the display element, the one side of the conductive film, and the sealing member.

10. The touch screen display device as claimed in claim 8, wherein an input signal is produced as a result of the conductive film coming into contact with the display element in response to a user's manipulation.

11. The touch screen display device as claimed in claim 9, wherein an input signal is produced as a result of the conductive film coming into contact with the display element in response to a user's manipulation.

12. The touch screen display device as claimed in claim 9, further comprising:
a tube disposed through the sealing member; and
a pressure control member connected to the air layer,
wherein the pressure control member is contracted or expanded in accordance with an external pressure to maintain balance between the air layer and the external pressure.

13. The touch screen display device as claimed in claim 12, further comprising a pressure control case formed at one side of the bracket,
wherein the pressure control member is received within the pressure control case.

14. The touch screen display device as claimed in claim 13, further comprising a through-hole formed in the pressure control case to connect the pressure control case to the outside.

15. A portable terminal comprising:
a receiver unit; and
a touch screen display device, the touch screen display device comprising:
a capacitive touch screen display element;
a conductive film provided on an outer surface of the display element; and
an air layer interposed between the display element and the conductive film,
wherein a gap is maintained between the outer surface of the display element and the conductive film by the air layer.

16. The portable terminal as claimed in claim 15, further comprising a protective film attached to an outer surface of the conductive film.

17. The portable terminal as claimed in claim 15, wherein a micro-current is applied to the conductive film simultaneously when the display element is activated.

18. The portable terminal as claimed in claim 15, wherein an input signal is produced as a result of the conductive film coming into contact with the display element in response to a user's manipulation.

19. The portable terminal as claimed in claim 15, further comprising a pressure control member connected to the air layer,
wherein the pressure control member is contracted or expanded in accordance with an external pressure to maintain balance between the air layer and the external pressure.

20. The portable terminal as claimed in claim 19, further comprising a protective film attached to an external surface of the conductive film.
